(19) United States
(12) Patent Application Publication
(10) Pub. No.: US 2014/0159838 A1
(43) Pub. Date: Jun. 12, 2014

(54) THERMOMAGNETIC POWER GENERATOR

(71) Applicant: DELTA ELECTRONICS, INC., Kuei San (TW)

(72) Inventors: Chung-Jung KUO, Kuei San (TW); Tze-Chern MAO, Kuei San (TW); Ming-Tsz LIN, Kuei San (TW); Chieh-Cheng LIU, Kuei San, (TW); Ming-Han LIN, Kuei San (TW)

(73) Assignee: DELTA ELECTRONICS, INC., Kuei San (TW)

(21) Appl. No.: 13/707,248

(22) Filed: Dec. 6, 2012

(51) Int. Cl. H01F 7/02

(52) U.S. Cl. CPC H01F 7/0242
USPC 335/217

(57) ABSTRACT

A thermomagnetic power generator is provided. The thermomagnetic power generator includes: at least one set of magnetic poles; at least a trough, filled with a fluid; and a plurality of chain links, linked into a closed chain, wherein each of the chain links is made of the magnetic material and a first part of the closed chain is inside the trough and immersed by the fluid while a second part of the closed chain is outside the trough and exposed to an environment. The fluid and the environment are at different temperatures, wherein the set of magnetic poles causes different forces on the first and the second part of the closed chain due to the thermomagnetic effect so as to generate a torque upon the closed chain to drive the closed chain.

### BACKGROUND OF THE INVENTION

1. Field of the Invention

The present invention relates to a power generator, and in particular relates to a power generator using a thermomagnetic effect.

2. Description of the Related Art

The thermomagnetic effect is a thermodynamic phenomenon in which a reversible change in magnetic field of a suitable material is caused by exposing the material to a changing temperature.

Specifically, the thermomagnetic effect is caused because the permeability of the suitable material (for example, magneto-caloric material) varies from temperature to temperature; especially, around the Curie temperature of the magneto-caloric material. FIG. 1 shows permeability versus temperature for a first order phase transition material 110 and a second order phase transition material 120. In FIG. 1, it can be found that the permeability of the first order phase material varies gradually while that of the second order phase material varies greatly around the Curie temperature (i.e., 294K in this Fig.).

By utilizing the thermomagnetic effect described above, the present invention provides a new apparatus for generating power.

### BRIEF SUMMARY OF THE INVENTION

The present invention provides a thermomagnetic power generator, which comprises: at least one set of magnetic poles; at least a trough, filled with a fluid; and a plurality of chain links, linked into a closed chain. Each of the chain links is made of the magnetic material and a first part of the closed chain is inside the trough and immersed by the fluid while a second part of the closed chain is outside the trough and exposed to an environment, wherein the fluid and the environment are at different temperature. The set of magnetic poles causes different forces on the first and the second part of the closed chain due to the thermomagnetic effect so as to generate a torque upon the closed chain to drive the closed chain.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the permeability versus the temperature for a first order phase transition material 110 and a second order phase transition material 120.

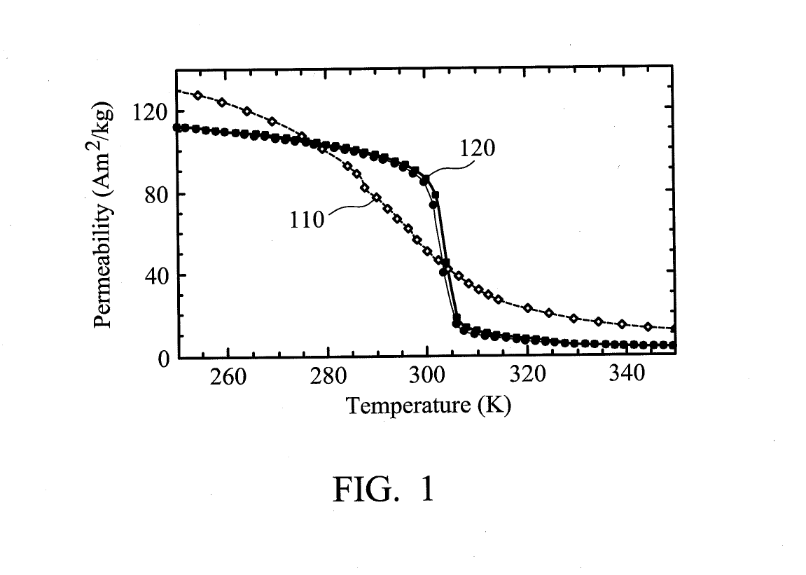

FIG. 2 is a schematic diagram of a thermomagnetic power generator according to a first embodiment of the present invention.

FIG. 3 is a schematic diagram of a thermomagnetic power generator according to a second embodiment of the present invention.

FIG. 4 is a schematic diagram of a thermomagnetic power generator according to a third embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### Embodiment 1

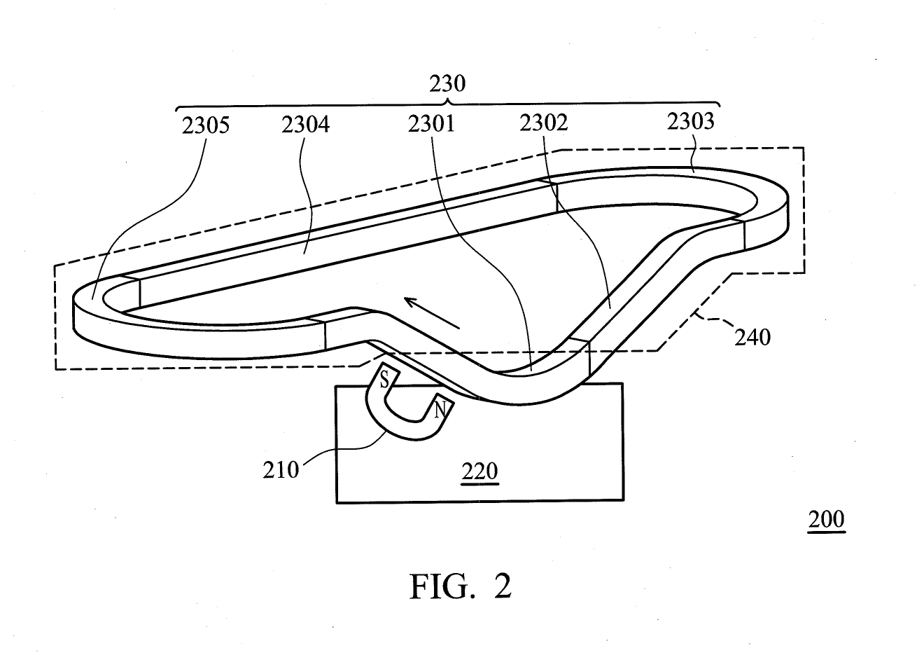

FIG. 2 is a schematic diagram of a thermomagnetic power generator according to a first embodiment of the present invention. The thermomagnetic power generator 200, as shown in FIG. 2, comprises a set of magnetic poles 210 (having an N pole and an S pole), a trough 220, and a plurality of chain links 2301, 2302, 2303, 2304 and 2305.

In this embodiment, the trough 220 is filled with a fluid (for example, water), and the fluid has a working temperature T_{H}. Outside the trough 220, the environment 240 where the thermomagnetic power generator 200 exists has an environment temperature T_{C}, which is different from (in this embodiment, lower than) the working temperature T_{H}.

The set of magnetic poles 210 is used to cause a magnetic field, and can be made of permanent magnetic material and disposed on any proper position. In this embodiment, the magnetic poles are both dipped into the fluid in the trough 220; however, the present invention should not be limited thereto, as long as a magnetic field is strong enough to affect the chain links 2301, 2302˜2305.

The chain links 2301, 2302˜2305 of the present invention are linked into a closed chain 230 which is arranged in a three-dimensional space. In the present invention, these chain links should be at least partially made of the magnetic material, and in a preferred embodiment, should be made of magneto-caloric material (MCM); especially, the second order phase transition MCM as described in the Description of the Related Art. For illustration, the chain links hereinafter are all made of MCM with a Curie temperature.

To explain the principles of the present invention, the closed chain 230 can be regarded as being composed of two parts: a first part and a second part, where the “first part” refers to the chain links which are inside the trough 220 and immersed by the fluid (in this embodiment, the first part of the closed chain 230 is the chain link 2301, as shown in FIG. 2), while the “second part” refers to the chain links which are outside the trough 220 and exposed to the environment 240 (in this embodiment, the second part of the closed chain 230 includes the chain links 2302, 2303, 2304 and 2305, as shown in FIG. 2). In this embodiment, the thermomagnetic power generator 200 can operate and be used in the environment (240) at an environment temperature (Tc) which is lower than the Currie temperature (e.g., 294K) of the MCM of the chain links 2301-2305. The working temperature T_{H} of the fluid in the trough 220 should be controlled (for example, by heating up) to exceed the Curie temperature (294K) of the MCM material of the chain links 2301-2305. Therefore, as the first part of the closed chain 230 (i.e., chain link 2301) slides into the trough 220 (due to gravity) and is heated by the fluid to the Curie temperature, the permeability of the first part at the working temperature T_{H} suddenly differs from that of the second part (i.e., chain links 2302˜2305) at the environment temperature T_{C} due to the thermomagnetic effect. Thus, the set of the magnetic poles 210 exerts different forces on the first and the second part of the closed chain 230, and the combined forces form a torque upon the closed chain 230 and drive the chain links 2301˜2305 to move. As the chain link 2301 moves in a direction (as shown by an arrow in FIG. 2) and gets out of the fluid and the trough 220 (and turns into the “second part” of the closed chain 230), the next chain link 2302 follows the chain link 2301 and slides into the trough 220 (and turns into the “first part” of the closed chain 230). As long as the working temperature of the fluid in the trough 220 is kept higher than of the Curie temperature of the MCM of the chain links 2301˜2305, the closed chain 230 can continuously and circularly move along the path where the chain links 2301˜2305 are.

The main components of the thermomagnetic power generator 200 have been fully described above, and other peripheral components such as the structures for support, or tracks for guiding the closed chain 230 have been omitted for purpose of brevity and clarity. Although the closed link 230 is arranged in a specific form, the present invention should not be limited thereto.

### Second Embodiment

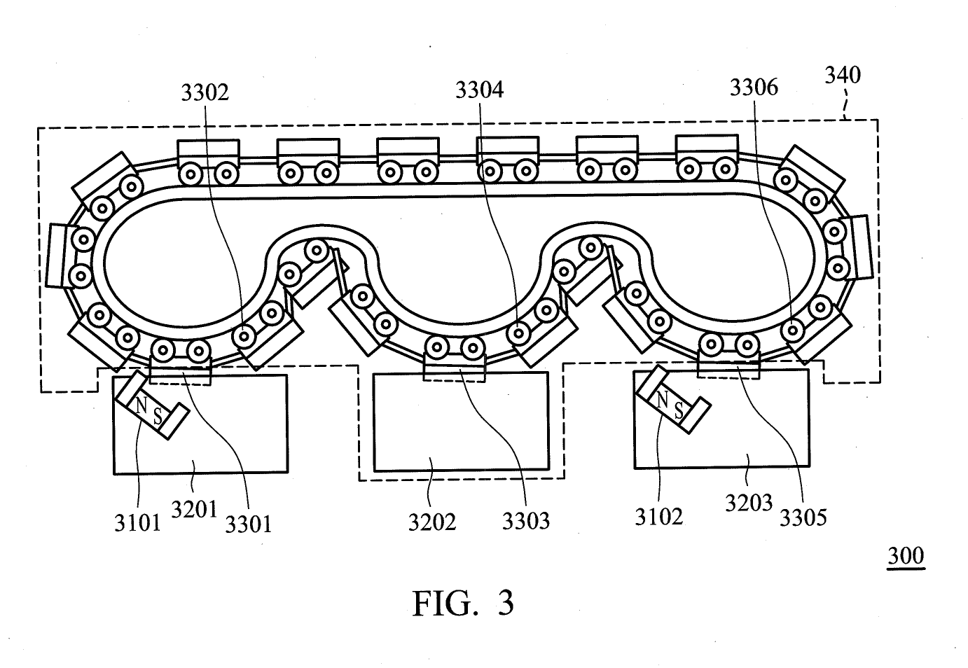

FIG. 3 is a schematic diagram of a thermomagnetic power generator according to a second embodiment of the present invention. Similar to the first embodiment, the thermomagnetic power generator 300 in the second embodiment comprises two sets of magnetic poles 3101 and 3102 (each has an N pole and an S pole), a plurality troughs 3201, 3202 and 3203, and a plurality of chain links 3301, 3302, 3303, 3304, 3305, 3306, etc (since the chain links in FIG. 3 substantially have the same structure, not all of them are labeled with a number). The sets of magnetic poles 3101 and 3102 are used to cause a magnetic field, and can be made of a permanent magnetic material and disposed on any proper position. In this embodiment, the two sets of the magnetic poles 3101 and 3102 are respectively dipped into the fluids of the first trough 3201 and third through 3203; however, the present invention should not be limited thereto, as long as the magnetic field caused is strong enough to affect the chain links 3301˜3306. The chain links 3301˜3306 in this embodiment are also linked into a closed chain 330. The chain links 3301˜3306 should be also made of magnetic material; especially, the second order phase transition magneto-caloric material (MCM). However, different from the first embodiment, it can be easily found in FIG. 3 that each of the chain links in this embodiment is built as a cart with wheels and guided by a track 350.

In this embodiment, the first and the third trough 3201 and 3203 are filled with fluids at a working temperature T_{H}. Outside the troughs 3201 and 3203, the environment 340 where the thermomagnetic power generator 300 exists has an environment temperature T_{C}, which is different from (in this embodiment, lower than) the working temperature T_{H}. It should be noted that in this embodiment, the environment 340 includes the second trough 3202 which is filled with a fluid with a temperature that is lower than the environment temperature T_{C} for further cooling down the temperature of the chair links 3301˜3306.

Similarly, the closed chain 330 can be regarded as being composed of two parts: a first part and a second part, where the “first part” refers to the chain links which are inside the first trough 3201 or the third trough 3203 and immersed by the fluid therein (the chain links 3301 and 3305), while the “second part” refers to the chain links which are outside the first and the third troughs 3201 and 3203 and exposed to the environment 340/immersed by the fluid in the second trough 3202 (the chain links 3302, 3303, 3304 and 3306). In this embodiment, the thermomagnetic power generator 300 can operate and be used in an environment (340) at the environment temperature (Tc) which is lower than the Currie temperature (e.g., 294K) of the MCM of the chain links 3301˜3306. The working temperature T_{H} of the fluids in the troughs 3201 and 3203 should be controlled (for example, by heating up) to exceed the Curie temperature (294K) of the MCM material of the chain links 3301˜3306. Therefore, as the first part of the closed chain 330 (i.e., chain links 3301 and 3305) slides into the troughs 3201 and 3203 (due to gravity) and is heated by the fluid to the Curie temperature, the permeability of the first part at the working temperature T_{H} suddenly differs from that of the second part (i.e., chain links 3302, 3303, 3304 and 3306) at the environment TC due to the thermomagnetic effect. Thus, the sets of the magnetic poles 3101 and 3103 exerts different forces on the first and the second part of the closed chain 330, and the combined forces form a torque upon the closed chain 330 and drive the chain links 3301˜3306 to move. As the chain links 3301 and 3305 move in a direction (as shown by an arrow in FIG. 3) and gets out of the troughs 3201 or 3203 (and turns into the “second part” of the closed chain 330), the chain links 3302 and 3306 follows the chain links 3301 and 3305 and respectively slides into the troughs 3201 and 3203 (and turns into the “first part” of the closed chain 330). As long as the working temperature T_{H} of the fluid in the trough 320 is kept higher than that of the Curie temperature of the MCM of the chain links 3301˜3306, the closed chain 330 can continuously and circularly move along the path where the chain links 3301˜3306 are. Compared with the first embodiment, the configuration of the additional troughs 3302 and 3303 is good for increasing the difference between the magnetic forces exerted to the first and the second part of the closed chain 330 and enhancing the sliding speed of the closed chain 330.

The main components of the thermomagnetic power generator 300 have been fully described above, and other peripheral components such as the structures for supporting the closed chain 330 have been omitted for purpose of brevity and clarity. Although the closed link 330 is arranged in a specific form, the present invention should not be limited thereto.

### Third Embodiment

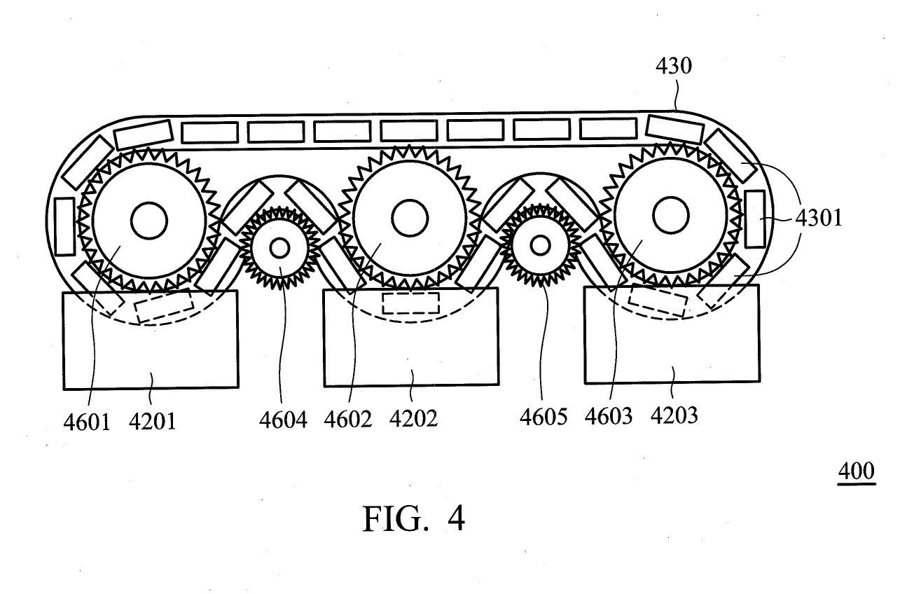

FIG. 4 is a schematic diagram of a thermomagnetic power generator according to a third embodiment of the present invention. Similar to the first or second embodiment, the thermomagnetic power generator 400 in the third embodiment comprises at least one set of magnetic poles (not shown since it can be disposed on any proper position), a plurality troughs 4201,4202 and 4203, and a plurality of chain links 4301 (since the chain links in FIG. 4 substantially have the same structure, so they are labeled with the same number). The chain links 4301 in this embodiment are also linked into a closed chain 430. The chain links 4301 should be also made of magnetic material; especially, the second order phase transition magneto-caloric material (MCM). Since those skilled in the art may refer to the embodiments described above to understand the principal of the present invention, how to generate a torque to drive the closed chain 430 in this embodiment will not be further discussed.

Different from the first or the second embodiments, the thermomagnetic power generator 400 in this embodiment further comprises a plurality of sprockets 4601, 4602, 4603, 4604 and 4605 (inside or outside of the area defined by the closed chain 430). Each of the sprockets 4601˜4606 is a wheel with numerous teeth for meshing with the closed chain 430. The sprockets 4601˜4606 meshing with the closed chain 430 can be driven and rotated by the closed chain 430, and the axle of the sprockets 4601˜4606 can be used for outputting the torque of the closed chain 430.

The main components of the thermomagnetic power generator 400 have been fully described above, and other peripheral components such as the structures for supporting the closed chain 430 have been omitted for purpose of brevity and clarity. Although the closed link 430 is arranged in a specific form, the present invention should not be limited thereto.

In addition, since there are various manners for linking the chain links in the previous embodiments, and components for connecting two chain links can be made of any proper material, they will not be further discussed in the present disclosure.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermomagnetic power generator, comprising:
at least one set of magnetic poles;
at least a trough, filled with a fluid; and
a plurality of chain links, linked into a closed chain, wherein each of the chain links is made of the magnetic material, and a first part of the closed chain is inside the trough and immersed by the fluid while a second part of the closed chain is outside the trough and exposed to an environment, wherein the fluid and the environment are at different temperatures,
wherein the set of magnetic poles causes different forces on the first and the second part of the closed chain due to the thermomagnetic effect so as to generate a torque upon the closed chain to drive the closed chain.

2. The thermomagnetic power generator as claimed in claim 1, wherein the magnetic material comprises a magneto-caloric material.

3. The thermomagnetic power generator as claimed in claim 2, wherein the fluid has a working temperature which is higher than a Curie temperature of the magneto-caloric material.

4. The thermomagnetic power generator as claimed in claim 3, wherein the environment has an environmental temperature that is lower than the Curie temperature of the magneto-caloric material.

5. The thermomagnetic power generator as claimed in claim 2, wherein the fluid has a working temperature lower than a Curie temperature of the magneto-caloric material.

6. The thermomagnetic power generator as claimed in claim 5, wherein the environment has an environmental temperature higher than the Curie temperature of the magneto-caloric material.

7. The thermomagnetic power generator as claimed in claim 1 further comprising:
at least a sprocket, meshing with the closed chain for outputting the torque.

8. The thermomagnetic power generator as claimed in claim 1, wherein the set of magnetic poles is made of a permanent magnetic material.
